(19) United States
(12) Patent Application Publication
(10) Pub. No.: US 2008/0253315 A1
(43) Pub. Date: Oct. 16, 2008

(54) Communication Network and a Communication Element and Method of Operation Thereof

(75) Inventor: Maarten Peter Bodlaender, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/571,639

(22) PCT Filed: Aug. 30, 2004
(86) PCT No.: PCT/IB04/51603

§ 371 Date: Mar. 14, 2006

(30) Foreign Application Priority Data
Sep. 16, 2003 (DE) 03103394.7

(51) Int. Cl. H04Q 7/00

(52) U.S. Cl. 370/328

(57) ABSTRACT

The invention relates to a communication network in which a first communication element (103) transmits an inquiry message to determine the presence of other communication elements (105, 107). A second communication element (105) comprises a receiver (113) for receiving the inquiry message. A controller (115), coupled to a timer (119), determines the duration in which the second communication element (105) has been in the current operating mode. If this is more than a threshold, it is likely that a reply message has already been sent in response to an earlier inquiry message and the current inquiry message is ignored. If the duration is less than the threshold, it is unlikely that a reply message has been sent and the second communication element (105) transmits a reply message. The invention allows for a reduction in reply messages in a communication network (100) and therefore for reduced interference and increased capacity.

The invention relates to a communication network and a communication element and method of operation therefor and in particular to a radio communication network.

In recent years, networking of electronic devices has become of increasing importance. Networking of personal computers based on wires or optical fibers have been known for some decades. However, in the last decade, networking of personal computers has become much more widespread as witnessed by the explosive growth of the Internet. In addition, an increasing number of standards for wireless networking have been developed, and it is expected that the adoption and introduction of wireless networking will be very significant over the next years.

In addition to the expected growth of wireless networking, it is also expected that an increasing number and types of electronic devices will be networked in the future and that networking will be deployed in fields traditionally not associated with networking. For example, it is expected that home networking where different home appliances and consumer equipment will be networked together will become increasingly widespread. For example, it is expected that networks may be used to electronically distribute stored music around a house from a central storage device. As another example, a household appliance such as washing machine may be networked with, say, a TV thereby allowing a message to be displayed on the TV when the washing machine has finished.

Examples, of wireless networks include WiFi (Trademark) and IEEE standards 802.11a, b and g which have been developed mainly for wireless computer networks, and Universal Plug and Play (UPnP) and Rendezvous protocols, which have been developed for home networks.

Most currently developed wireless networks tend to be ad-hoc networks where the configuration and operating conditions change dynamically as new network elements enter and leave the network. For example, a given consumer device may only be online in the network when it is switched on whereas other devices may be portable and therefore may form and break connections to different network elements as the portable device moves within the network. Furthermore a portable device may leave the network for example if it is removed from the coverage area of the network

In most ad-hoc networks, a centralized access point is included to which the wireless network elements communicate. Communication between two wireless network elements is performed using the access point as an intermediate network element. Hence, data from one wireless communication element is routed through the access point to another wireless communication element. A plurality of access points may be provided in a wireless network and data may be routed between these to effect a communication connection.

Many wireless network standards including home network standards and protocols such as UPnP and Rendezvous have a device detection function known as “discovery”, and which allows devices to discover which other devices are currently present in the network. Typically, devices either search for other devices and/or devices announce themselves. For example, applications that require an up-to-date view of a home network (for example presenting a house-map with the state of the home network on a user interface) tend to use a mix of these two mechanisms to optimize the consistency of the generated network overview. A search may be instigated by a device broadcasting a search message and all messages receiving the message may reply by transmitting a device identity to the search device.

Typically, due to changes in network configuration and the possibility of lost messages, both searches and announcements may be inaccurate. Therefore, applications periodically search for devices to ensure that the current configuration is determined despite e.g. missed announcements.

However, a known problem with search and announcement mechanisms is that a large number of search, announcement and reply messages may be generated which results in a large part of the available air interface resource being used by these messages. For example, if one or more devices periodically transmit a search message in a radio network, the many reply messages from the devices may cause a significantly increased interference level which may degrade or hinder other user data communications. In order to ensure that the interference is sufficiently low, the frequency of the searches is limited thereby resulting in a slow update rate of e.g. applications determining the current network configuration. This results in a reduced user interface and may be critical for some applications and in particular for portable devices.

Some solutions have been proposed addressing these problems.

Specifically, it has been proposed that a list of known devices is included in the search request and that devices only reply if their identity is not included in the list. However, this increases the complexity of the processing of devices involved in the search and results in search messages of increasing size thereby requiring more resources for transmission. Furthermore, the size of the message may vary and in particular grows as more and more devices are detected. Hence, the search message will be larger for more populated networks which typically corresponds to networks already having high resource demands.

It has also been proposed to include a message identity in the search request and sending repeat search requests with the same message identity. All devices will store the message identities of search messages to which they have already replied and only reply to new identities. However, this increases the complexity of the processing of devices involved in the search and specifically requires that all devices maintain a list of message identities of all search messages replied to, and that this list is searched every time a new message is received.

Hence, an improved network element and system would be advantageous and in particular one allowing for a device detection having increased flexibility, reduced resource consumption, reduced complexity and/or reduced processing requirements would be advantageous.

Accordingly, the Invention preferably seeks to mitigate, alleviate or eliminate one or more of the above mentioned disadvantages singly or in any combination.

According to a first aspect of the invention, there is provided a communication element for a communication network comprising: means for receiving an inquiry message from an inquiring communication element; means for determining a duration of a first operating mode of the communication element; and means for transmitting a reply message in response to the duration.

The invention allows for the reply message to be in response to a duration of a first operating mode. In many communication networks, the probability of a communication element having already replied to an inquiry message (or specifically a search message) depends on the duration in which the communication element has been in a specific operating mode. Hence, this allows for a reduction in the number of reply messages which are transmitted and accordingly the resource requirement may be reduced. Furthermore, the required functionality to determine a duration is very simple and a reduced complexity and/or reduced processing requirement may be achieved.

For example, the communication element may be operable to operate in an inquiry reply mode and in an inquiry ignore mode and the first mode of operation may be the inquiry reply mode. The inquiry reply mode may be an active mode and the inquiry ignore mode may be an idle, dormant, inactive and/or power conserving mode.

According to a feature of the invention, the first operating mode is a current operating mode. This allows for example for a reply message being generated only if the communication element has been in the current operating mode for less than a given duration. For example, in many wireless communication networks, inquiry or search messages may be sent frequently and if the current operating mode is one wherein search messages are replied to, it is highly probable that the communication element has replied to inquiry messages within a given duration. Hence, reduced resource consumption by device detection mechanisms may be achieved.

According to a different feature of the invention, the first operating mode is an online operating mode. The duration in which a communication element has been in an online mode is a suitable measure of the probability that a reply message has already been sent to the other communication element. The duration of the online mode may specifically be the time interval in which a communication element is operable to receive inquiry messages from and transmit reply messages to the communication network.

According to a different feature of the invention, the means for transmitting is operable to transmit the reply message only if the duration is below a threshold.

The threshold may be predetermined or may be determined in response to for example operating parameters of the communication element and/or the communication network. This provides for a suitable and easy to implement way of controlling the transmission of reply messages. Specifically a reduction in the communication of reply messages may be achieved while having a low complexity and/or processing requirement.

According to a different feature of the invention, the communication element further comprises means for varying the threshold. This allows for the threshold to be optimized for the current operating condition. Specifically, the threshold may be varied to ensure that a sufficient probability of a previous reply message having been transmitted and/or successfully received is sufficiently high.

According to a different feature of the invention, the means for varying the threshold is operable to vary the threshold in response to an interference level of the communication network. This allows the threshold to be optimized for the current interference levels. Typically, the probability of a transmitted reply message being successfully received by the other communication element depends on the signal to interference ratio and thus on the interference level. Hence, at low interference levels only few reply messages are required to achieve a desired probability of successful reception whereas at higher interference levels more transmitted reply messages may be required. The threshold may for example be set to result in enough reply messages being transmitted to achieve a given probability of successful reception.

According to a different feature of the invention, the means for determining is operable to determine the duration as the duration the communication element has been connected to the communication network. The duration in which the communication element has been connected to the network is a suitable measure of the probability that a reply message has already been sent to the other communication element.

According to a different feature of the invention, the communication element further comprises a timer and means for initiating the timer when the communication element enters the first operating mode. This may provide for a simple, efficient and easy to implement means of determining the duration.

According to a different feature of the invention, the communication element further comprises means for stopping the timer when a timing value reaches a given threshold. This allows for a power reduction and/or processing reduction of the communication element.

According to a different feature of the invention, the means for determining is operable to generate an indication if no valid duration of the first operating mode can be determined and the means for transmitting is operable to transmit a no duration indication reply message in response to the indication.

This allows for suitable performance if a duration cannot be determined and allows for the other communication element to be aware that the reply message is received despite possibly having been received before.

The communication network is preferably a wireless communication network and specifically a radio communication network such as for example a WiFi, IEEE 802.11, wired communication networks like 802.3, combined with one or more middleware protocols like UPnP or Rendezvous.

According to a second aspect of the invention, there is provided a communication network comprising: a first communication element operable to transmit an inquiry message; a second communication element comprising: means for receiving the inquiry message; means for determining a duration of a first operating mode of the second communication element; and means for transmitting a reply message in response to the duration and the inquiry message.

According to a feature of the invention, the first communication element is operable to include a reply message decision criterion in the inquiry message and the means for transmitting is operable to transmit the reply message in response to the reply message decision criterion.

The reply message decision criterion may be directly and explicitly comprised in the reply message and/or the reply message may comprise information allowing for the reply message decision criterion to be generated locally.

This may allow the first communication element to control the performance of other devices. Specifically, it may allow for a searching communication element to control the probability of all communication elements being detected. Hence, the performance may be optimized for the requirements of the specific application.

According to a feature of the invention, the decision criterion is a duration indication and the means for transmitting is operable to transmit the reply message in response to the duration indication. This provides a suitable and low complexity d reply message decision criterion.

According to a feature of the invention, the decision criterion is a duration threshold and the means for transmitting is operable to transmit the reply message only if the duration is less than the duration threshold. This allows for a particularly simple yet efficient implementation.

According to a feature of the invention, the first communication element is operable to include a time indication in the inquiry message and the means for transmitting is operable to transmit the reply message in response to the time indication. This allows for example the duration or a decision threshold to be determined in response to a time of a specific event or occurrence.

According to a feature of the invention, the time indication is an indication of a time of a previous inquiry message. This may provide particularly suitable and efficient performance. For example, the second communication element may only reply to an inquiry message if the duration of the first operating mode is less than the difference between the current time and the time of the previous message. Hence, this may allow for a very simple way of ensuring that only one reply message is sent to the communication element.

According to a third aspect of the invention, there is provided a method of operating for a communication element of a communication network comprising: receiving an inquiry message from an inquiring communication element; determining a duration of a first operating mode of the communication element; and transmitting a reply message in response to the duration.

These and other aspects, features and advantages of the invention will be apparent from and elucidated with reference to the embodiment(s) described hereinafter.

An embodiment of the invention will be described, by way of example only, with reference to the drawings, in which

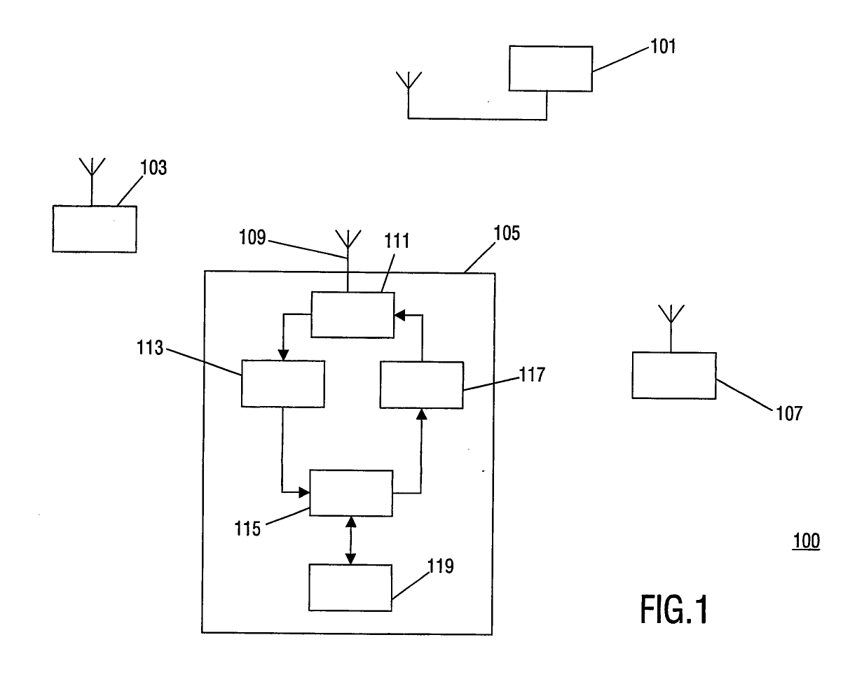

FIG. 1 is an illustration of a wireless communication network in accordance with an embodiment of the invention.

The following description focuses on an embodiment of the invention applicable to a radio communication network such as a UPnP, WiFi or IEEE 802.11 communication network. However, it will be appreciated that the invention is not limited to this application but may be applied to many other wireless, or wired communication networks or combinations thereof. For example, a wireless access point may bridge a wireless network to a wired network. For example, devices on the wireless network may be laptops, PDAs, remote controls, and devices on the wired network may be the stationary devices like home media server, TV, internet gateway, large stereo set.

FIG. 1 is an illustration of a wireless communication network 100 in accordance with an embodiment of the invention.

The illustrated wireless communication network comprises single access point 101 to (and through) which all wireless communication elements communicate. For brevity and clarity, the wireless communication network 100 of FIG. 1 is illustrated comprising three communication elements 103, 105 and 107 but it will be appreciated that a practical wireless communication network may comprise many more active or inactive communication elements.

In the illustrated example, the different communication elements may for example correspond to personal computers, consumer electronic devices, home appliances, printer servers, personal digital assistants or any other suitable type of device.

In the specific embodiment, a first communication element 103 maintains a plan of the current configuration and topology of the wireless communication network 100. Accordingly, the first communication element 103 periodically transmits inquiry messages to the wireless communication network 100 requesting that currently active or connected communication elements transmit a reply message comprising a communication element identification.

Specifically, the first communication element 103 periodically transmits an inquiry message to the access points 101 which then broadcasts it to all wireless communication elements 105, 107.

The functionality of a second network element 105 is illustrated in more detail in FIG. 1.

The second network element 105 comprises an antenna 109 for receiving and transmitting messages to and from the access point 101. The antenna 109 is coupled to a duplexer 111 which isolates transmit and receive signals thereby allowing the antenna 109 to be used for both transmitting and receiving.

The duplexer 111 is coupled to a receiver 113 which is operable to receive messages from the access point 101 and accordingly to receive messages from other communication elements through the access point 101. In particular, the receiver 113 is operable to receive an inquiry message transmitted from the first communication element 103.

The second communication element 105 comprises a controller 115 which controls the operation of the second communication element 105 and in particular controls the receive and transmit functionality associated with communication to the access point 101.

The controller 115 is coupled to the receiver 113 and is furthermore coupled to a transmitter 117 which is further coupled to the duplexer 111. The transmitter 117 is operable to transmit messages to the access point 101 and through the access point 101 to other communication elements. Specifically, the transmitter 117 is operable to transmit a reply message to the first communication element 103 in response to an inquiry message received therefrom. In the illustrated example, the transmission of reply messages is controlled by the controller 115.

The second communication element 105 furthermore comprises a timer 119 coupled to the controller 115. The timer is controlled by the controller 115 and in particular the controller 115 is operable to start, stop and read the timer 119.

In use, the controller 115 is operable to determine a current operating mode of the second communication element 105. In a simple embodiment, the determination of operating mode may simply comprise in determining if the second communication element 105 is switched on or off. However, in the preferred embodiment, the controller 115 is operable to determine if the second communication element 105 is in an online or offline configuration. In the online configuration, the second communication element 105 is operable to transmit and/or receive messages through the wireless communication network 100. The offline configuration or operating mode may be a dormant, idle or power conserving mode of the second communication element 105.

For example, if the second communication element 105 is a portable games console this may be used for a single player game without any communication to other communication elements. In this case, the portable games console may power down any functionality associated with network communication in order to conserve battery power. However, the portable games device may also operate in a second operating mode or configuration wherein an online multiplayer game is played. In this case, the portable games device will power up the network functionality and transmit and receive messages from the access point as appropriate.

In the described embodiment, the controller 115 initiates and starts the timer 119 when it enters a new operating mode or configuration. Specifically, the controller 115 may initiate the timer 119 when it powers up or may initiate the timer 119 when it enters an online configuration. Accordingly, the timer 119 will indicate the duration in which the second communication element 105 has been in the current operating mode.

When the first communication element 103 transmits an inquiry message, this will be forwarded by the access point 101. Accordingly, the receiver 113 of the second communication element 105 will receive the inquiry message and forward this to the controller 115. In response, the controller 115 will access the timer 119 to determine the duration in which the second communication element 105 has been in the current operating mode.

If the duration is less than a given threshold, the controller 115 will generate a suitable reply message and control the transmitter 117 to transmit the reply message to the first communication element 103 through the access point 101. Dependent on the application and the standards for the specific wireless communication network the reply message may comprise different information. In a simple implementation, the reply message simply comprises an identity of the second communication element 105. If the duration is above the threshold, the controller 115 simply ignores the inquiry message and does not generate or transmit a reply message.

Accordingly, a reply message is only transmitted if the second communication element 105 has been in the current operating mode for less than a given duration. If the first communication element 103 periodically transmits inquiry messages it is highly likely that after a given duration, the first communication element 103 has already received a reply message from the second communication element 105 and therefore further reply messages are unnecessary.

For example, if the first communication element 103 transmits an inquiry message every 2 seconds, a total of five reply messages may be sent by the second communication element 105 within a duration of 10 seconds. It is highly unlikely that all five messages have been lost and therefore the probability that the first communication element 103 has not detected the second communication element 105 after 10 seconds is negligible. Accordingly, any further reply messages are unnecessary and may be discarded.

Accordingly, the approach allows for a reduction in the number of reply messages being transmitted in a wireless communication network and thus may significantly reduce the interference resulting therefrom. Hence, not only may the described embodiment provide for power reduction and reduced complexity of the individual communication element but the performance of other communication elements and the wireless communication network as a whole may be improved. Furthermore, the advantages may be produced by very simple and low complexity means. For example, the timer may simply be implemented as a short subroutine of a firmware program of the controller.

In some embodiments, the controller 115 may be operable to stop the timer 119 when a timing value reaches a given threshold. Specifically, the timer 119 may be stopped when it reaches the value corresponding to the threshold for determining if a reply message is to be transmitted. This allows for the timer only to be active when necessary, and may allow for reduced power consumption or simplified processing. For example, the controller firmware may simply set a flag indicating that the timing value exceeds the threshold for sending reply messages and subsequently stop calling the timer subroutine.

In some embodiments, the second communication element 105 may also transmit reply messages or announcements when entering e.g. an offline, inactive or power down mode. This will allow the first communication element 103 to detect when the second communication element 105 enters an inactive mode. Specifically, in some embodiments, reply messages may be sent for a duration following every change in operating mode or configuration thus resulting in the absence of reply messages indicating that no change has occurred.

It will be appreciated that the threshold for sending reply messages may be set to any suitable value suitable for the application and operating conditions. For example, the threshold may vary to reflect dynamic changes in the operating conditions of the wireless communication network or the second communication element.

As a specific example, the interference in a radio communication network may vary significantly depending on the number of active communication elements and the current communication requirements of these. Interference may further vary due to external interference sources. The probability of a reply message not being correctly received depends on the interference level. Accordingly, the duration threshold may be varied in accordance with the interference level in order to ensure that the probability of all reply messages being lost is sufficiently low.

Specifically, the access point 101 may comprise means for determining an interference level and to broadcast this to the communication elements 103, 105, 107. In response the individual communication elements 105, 107 may set the duration threshold in accordance with e.g. a common predetermined algorithm. Specifically, an increasing function for the threshold as a function of interference may be prescribed.

In some cases, the second communication element 105 may not be able to determine a valid duration in which it has been in the current configuration. In this case, the second communication element 105 preferably transmits a reply message in response to all inquiry messages. The reply message is preferably a specific no duration indication reply message comprising information indicating that the reply message has been transmitted without any consideration of the duration of the current operating mode.

In some embodiments, the inquiry message from the first communication element 103 comprises a reply message decision criterion. In a simple, embodiment, the reply message decision criterion is simply an indication of the duration after which the other communication elements need not reply. Thus, the inquiry message may explicitly comprise the duration threshold which is to be used by the second communication element 105 to determine if a reply message is to be transmitted. This allows the communication element performing the search to control the performance of the responding communication elements thereby allowing the searching communication element to optimize the search for the specific application.

It will be appreciated that any suitable reply message decision criterion may be included in the inquiry message and that this may be an explicit or implicit, direct or indirect indication of the decision criterion. For example, the inquiry message may comprise information allowing the responding communication elements to themselves derive the specific criterion to use.

In some embodiments, the inquiry message may further comprise a time indication of a specific event and this may be used in determining if a reply message should be sent. Specifically, the inquiry message may comprise information indicating when the previous inquiry message was transmitted. The second communication element 105 may use this time indication to determine if it has been in the current operating mode for a duration which includes this time instant. If so, it is likely that a reply message has already been transmitted and it may therefore ignore the current inquiry message.

As another more complex example of a decision criteria, this may provide that a message should be sent if the device has been online for less than 1 minute, between 10 and 11 minutes, between 20 and 21 minutes etc. This could result in the device replying every ten minutes thus ensuring that if all messages are missed in the first minute, the device will at least be detected after 10 minutes rather than never.

The invention can be implemented in any suitable form including hardware, software, firmware or any combination of these. However, preferably, the invention is at least partly implemented as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with the preferred embodiment, it is not intended to be limited to the specific form set forth herein. Rather, the scope of the present invention is limited only by the accompanying claims. In the claims, the term comprising does not exclude the presence of other elements or steps. Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is no feasible and/or advantageous. In addition, singular references do not exclude a plurality. Thus references to “a”, “an”, “first”, “second” etc do not preclude a plurality.

1. A communication element (105) for a communication network (100) comprising:
means (113) for receiving an inquiry message from an inquiring communication element;
means (115) for determining a duration of a first operating mode of the communication element; and
means (117) for transmitting a reply message in response to the duration.

2. A communication element as claimed in claim 1 wherein the first operating mode is a current operating mode.

3. A communication element as claimed in claim 1 wherein the first operating mode is an online operating mode.

4. A communication element as claimed in claim 1 wherein the means (117) for transmitting is operable to transmit the reply message only if the duration is below a threshold.

5. A communication element as claimed in claim 4 further comprising means for varying the threshold.

6. A communication element as claimed in claim 5 wherein the means for varying the threshold is operable to vary the threshold in response to an interference level of the communication network (100).

7. A communication element as claimed in claim 1 wherein the means (115) for determining is operable to determine the duration as the duration the communication element (105) has been connected to the communication network (100).

8. A communication element as claimed in claim 1 further comprising a timer (119) and means for initiating the timer when the communication element (105) enters the first operating mode.

9. A communication element as claimed in claim 8 further comprising means for stopping the timer (119) when a timing value reaches a given timing threshold.

10. A communication element as claimed in claim 1 wherein the means (115) for determining is operable to generate an indication if no valid duration of the first operating mode can be determined and the means (117) for transmitting is operable to transmit a no duration indication reply message in response to the indication.

11. A communication element as claimed in claim 1 wherein the communication network (100) is a radio communication network.

12. A communication network (100) comprising:
a first communication element (103) operable to transmit an inquiry message;
a second communication element (105) comprising:
means (113) for receiving the inquiry message;
means (115) for determining a duration of a first operating mode of the second communication element (105); and
means (117) for transmitting a reply message in response to the duration and the inquiry message.

13. A communication network as claimed in claim 12 wherein the first communication element (103) is operable to include a reply message decision criterion in the inquiry message and the means (117) for transmitting is operable to transmit the reply message in response to the reply message decision criterion.

14. A communication network as claimed in claim 13 wherein the decision criterion is a duration indication and the means (117) for transmitting is operable to transmit the reply message in response to the duration indication.

15. A communication network as claimed in claim 14 wherein the decision criterion is a duration threshold and the means (117) for transmitting is operable to transmit the reply message only if the duration is less than the duration threshold.

16. A communication network as claimed in claim 12 wherein the first communication element (103) is operable to include a time indication in the inquiry message and the means (117) for transmitting is operable to transmit the reply message in response to the time indication.

17. A communication network as claimed in claim 16 wherein the time indication is an indication of a time of a previous inquiry message.

18. A communication network as claimed in claim 12 wherein the communication network is a radio communication network.

19. A method of operating for a communication element (105) of a communication network (100) comprising:
receiving an inquiry message from an inquiring communication element (103);
determining a duration of a first operating mode of the communication element 105), and
transmitting a reply message in response to the duration.

20. A computer program enabling the carrying out of a method according to claim 19.

21. A record carrier comprising a computer program as claimed in claim 20.
